(19) United States
(12) Patent Application Publication
(10) Pub. No.: US 2014/0329059 A1
(43) Pub. Date: Nov. 6, 2014

(54) ARTICLE OF ORNAMENTED TEXTILE WITH ADHESIVE-LAMINATED PARTICLES AND METHOD OF PRODUCING THE SAME

(71) Applicant: Diane Fujii Johnson, Honolulu, HI (US)

(72) Inventor: Diane Fujii Johnson, Honolulu, HI (US)

(73) Assignee: HAUTE SAND INC., Honolulu, HI (US)

(21) Appl. No.: 14/336,321

(22) Filed: Jul. 21, 2014

Related U.S. Application Data
(62) Division of application No. 13/543,800, filed on Jul. 7, 2012.
(60) Provisional application No. 61/628,881, filed on Nov. 7, 2011.

(51) Int. Cl. B44F 5/00; A41B 1/08

(52) U.S. Cl. CPC B44F 5/00; A41B 1/08
USPC 428/196

(57) ABSTRACT

A method for applying an ornamented design on a substrate employs small-grain particles of a selected range of particle sizes. A film-forming adhesive in liquid form is applied as a bottom adhesive layer on the substrate within outlines of a decorative pattern. The small-grain particles are distributed on the still-wet bottom adhesive layer. A top adhesive layer is applied on the layer of small-grain particles on the adhesive bottom layer. The two adhesive layers merge and are cured to form a flexible film with the layer of small-grain particles permanently embedded therein and adhered to the substrate. In a preferred method and resulting product, sand particles are used to form a decorative pattern on fabric for a T-shirt or other clothing item. Decorative designs may also be formed with other types of small-grain particles, on other types of substrates, and/or for other types of clothing, wearing apparel, or decorative items.

This U.S. Patent Application claims the priority of U.S. Provisional Patent Application 61/628,881, filed Nov. 7, 2011, by the same inventor.

### TECHNICAL FIELD

The present invention relates to an ornamented fabric product having an ornamented design of adhesive-laminated particles, and method of producing the same.

### BACKGROUND ART

Ornamented design layers have been applied to fabric to form an ornamented item of clothing, for example, T-shirts decorated with applique, decals, and thermoplastic transfer images. A well-known method employs heat-plasticizable transfer of a graphical image printed or embedded in a layer of thermoplastic material under heat and pressure, so that the thermoplastic material flows sufficiently into interstices of the fabric to form a good bond of the layer to the fabric without degrading or distorting the image or colors of the graphical design.

Another method of applying an ornamented design to fabric uses an adhesive layer in liquid form to hold flock material deposited in a design on the adhesive layer while it is still wet and sticky. In the industry, the term “flock” generally refers to short lengths of textile or animal fibers in tufts, felt, other aggregates, ceramic or metalized particles. These materials exhibit no reactions to the adhesive and, as a result, the bonding of these materials to fabric is solely due to surface-to-surface adhesion between the materials and the adhesive layer on which they are deposited. The bond is of low magnitude, and it is found that the materials can often become dislodged or pulled off when the clothing item is washed or dried. Consequently, the design on the clothing item can become degraded or dull over time.

### SUMMARY OF INVENTION

It is an object of the present invention to provide a method of applying an ornamented design of small particles on fabric which overcomes the aforementioned drawbacks. It is a specific object to provide a preferred method for applying an ornamented design formed from sand particles on fabric, which may be used to produce decorative clothing items for luxury brands and resort markets.

It is a particular object of the invention to provide a method of applying an ornamented design formed by sand particles on fabric by laminating the sand particles in an adhesive layer in a manner that forms a very strong bond of the sand particle design on the fabric. It is yet a further object that the method of laminating a sand particle design on fabric result in an ornamented product that is long-lasting, easy to produce on a mass scale, and inexpensive.

In accordance with the present invention, a method of applying an ornamented design formed from small-grain particles on a flexible, porous substrate comprises:

(a) preparing small-grain particles to be within a range of selected small or fine particle sizes and free of dust and other debris;

(b) applying a film-forming adhesive material in a liquid form first as a bottom adhesive layer on the fabric substrate within outlines of a decorative pattern to be formed on the substrate;

(c) distributing the selectively sized, small-grain particles in adhesive contact with the still-wet bottom adhesive layer on the substrate;

(d) applying a film-forming adhesive material in a liquid form secondly as a top adhesive layer in adhesive contact with the layer of small-grain particles on the adhesive bottom layer, so that the two adhesive layers merge and form a homogenous adhesive layer embedding the layer of small-grain particles in between them; and

(e) curing the homogenous adhesive layer to form a flexible film with the layer of small-grain particles permanently embedded therein and adhered to the substrate.

In a preferred embodiment, the small-grain particles are sand particles laminated in an adhesive film formed by cured plastisol ink layers. The plastisol ink contains polyvinyl chloride (PVC) particles in a plasticizer carrier that is heated and cured with infrared radiation. The sand decoration is applied to fabric for clothing and accessory items such as T-shirts, bags, and other items for luxury brands and resort markets. The sand-decorated fabric is completely machine-washable repeatedly without any substantial degrading or dulling of the design image. The sand particles can be of randomized natural color and composition or colored, and may be screened to a particular size range. A preferred range of sand particle sizes is from 0.075 mm to 2.0 mm in diameter.

The adhesive layer may be applied to a fabric substrate within outlines for a decorative pattern or design image or word(s). The top and bottom layers of film forming adhesive may be applied with a screen stencil commonly found in the industry, or in any manner well known to the art including, for instance, silk screen printing, roller printing and stamp printing. Different screen or mesh sizes can be used to control the amount of adhesive in the top and bottom layers. The top and bottom layers of adhesive may be applied using the same screen or template, or mixed and matched in any number of combinations to produce the desired effect. The adhesive layer, upon curing, will form a flexible film that strongly adheres to the fabric substrate. The wet adhesive can penetrate into the fabric substrate to enhance its bond therewith if no ink base is used. Other flexible substrates of materials other than fabric may be used, for example, paper or nonwoven fibrous substrates.

The application of sand particles on the wet adhesive bottom layer may be effected in any desired manner. For example, the particles can be blown onto the still-wet adhesive layer in a stream of cool air, or a mass of particles can be cascaded across patterned adhesive layer on the fabric substrate, or the substrate can be contacted with or conveyed through a mass of sand particles. Pressure may be applied to the sand particles adhered to the adhesive layer, for example, by using hand-applied pressure, with or without the use of any tools, or by passing the substrate with particles thereon under a blank silk-screen and allowing a squeegee to apply pressure as it would in a screen-printing process. The pressure ensures impregnation of the adhesive material as a coating at least partially embedding the sand particles. The extraneous particles not bonded in the adhesive layer may be removed by blowing a stream of air across the substrate, agitating, or by vacuuming, leaving only the sand that has been embedded in the adhesive layer.

The second (top) layer of adhesive may be applied in any manner well known to the art including, for instance, silk screen printing, stencil printing, roller printing and stamp printing. The adhesive top layer is still wet and sticky so that it laminates the sand material between it and the bottom adhesive layer. The top and bottom adhesive layers merge to form a homogenous layer embedding the layer of sand particles in between, and thereby provides a very strong bond of the sand particles on the fabric.

Solidifying the adhesive layers may be performed on a conveyor dryer common in the industry and may be cured at suitable temperatures such as about 300 degrees F. The time required for setting, i.e. solidifying, of the adhesive layers may vary depending upon the thickness of the adhesive layers and the embedded particulate size.

After the adhesive layers have been set, any surplus particles not bonded to the adhesive may be removed, for instance, by brushing, either manually or with a machine, or shaking the ornamented substrate, or by applying pressured air.

The resulting ornamented fabric article will retain the freshness of the decorative design and longevity of the sand particle layer through many washing or drying cycles.

Other objects, features, and advantages of the present invention will be explained in the following detailed description of preferred embodiments of the invention having reference to the appended drawings.

### BRIEF DESCRIPTION OF DRAWINGS

FIG. 1 illustrates sand particles of various particulate size ranges for application of a decorative sand design on a fabric substrate in a preferred embodiment.

FIG. 2 is a plan view schematically showing the fabric substrate having an ornamented design formed of sand particles deposited on an adhesive layer.

FIG. 3 is a side view schematically showing the fabric substrate having the ornamented design formed of sand particles suspended in top and bottom layers of adhesive pressed together to form a homogenous layer embedding the sand particles.

FIG. 4 illustrates an example of a resulting ornamented design of sand particles formed on the front of a T-shirt.

### DESCRIPTION OF PREFERRED EMBODIMENTS

In the following detailed description of the invention, certain preferred embodiments are illustrated providing certain specific details of their implementation. However, it will be recognized by one skilled in the art that many other variations and modifications may be made given the disclosed principles of the invention.

In a preferred method described herein, an ornamented design is formed by a layer of sand particles embedded in a bottom layer of patterned, adhesive material and top-coated with a top layer of adhesive material on a fabric substrate. The preferred method may be used to produce decorative clothing and accessory items such T-shirts and bags for luxury brands and resort markets. However, it is to be understood that the principles disclosed herein may be used to form decorative designs with other types of small-grain particles, on other types of substrates, and/or for other types of clothing, wearing apparel, soft goods, or decorative items.

### Preparation of Sand Particles

As used herein, “sand” or “small-grain particles” refers to any particulate material, either naturally occurring or man-made, that is within a range of small or fine particle sizes and has a characteristic of forming a relatively even layer when poured or distributed on a flat surface. In the preferred embodiment of a sand decorative design, a preferred range of sand particle sizes is from 0.075 mm to 2.0 mm in diameter.

Natural sand should first be washed with water, while being agitated either manually or mechanically, to remove dirt sediment, and other organic matter. Washing also dissolves any salt crystals present in the sand, which may disrupt the adhesion process or dissolve when the textile is washed, thereby degrading the design image. The sand washing process may be repeated a number of times, or until the runoff water runs clear to the human eye.

In preparation for drying, the wet, washed sand may be spread evenly across a boxed frame with a screen mesh bottom having a hole size at the low end of the preferred particle size range, i.e., 0.075 mm mesh hole size. Water may be sprayed evenly across the surface of the sand in the screen mesh box, in a back-and-forth pattern covering the entire area of sand. This causes dust, dirt, and smaller particles to sink to the bottom and pour out through the screen mesh. The sand filtering process may be repeated a number of times, or until there is no visible sediment leaching from the sand.

The remaining sand may be left to dry in the screen mesh box elevated at an angle to allow for air flow around the bottom. It may be allowed to air dry, dry in the sun, or put into a drying apparatus or have heated air blow over the sand. To decrease drying time, the sand may be raked to create rows of elevated and depressed areas of sand, increasing the surface area and thus allowing the sand to dry quicker. Any unwanted items found in the sand, such as broken bits of plastic or foreign matter, should also be removed. While these plastics or foreign matter may not disrupt the adhesion process, an unnatural color in the final sand layer may be seen as a defect in the product.

Dry screening may be used to prepare the sand by eliminating sand outside the usable range. First, the dry sand is passed through a screen using the force of gravity combined with either mechanical or manual agitation. This screen may have a hole size at the high end of the preferred particle size range, e.g., 2.0 mm hole size to remove any particles larger than 2.0 mm. The remaining sand grains will be smaller than 2.0 mm. This initially screened sand may then be passed through a second screen having a hole size at the low end of the preferred particle size range, e.g., 0.075 mm hole size. The resulting sand mixture will have sand in the preferred particle size range of 0.075 mm to 2.0 mm.

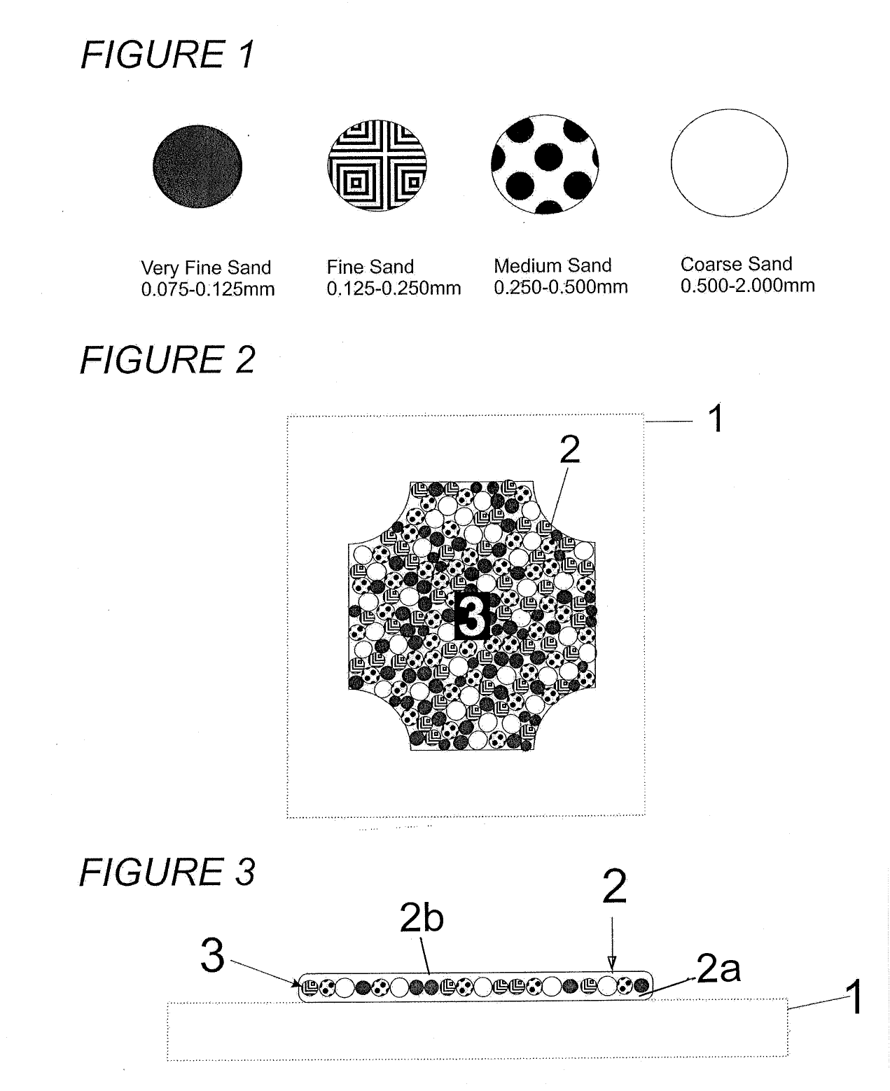

As indicated in FIG. 1, sand particles in the preferred particle size range may be categorized in four grades:

| | | |
|---|---|---|
| Coarse Sand | 0.5 to 2.0 | mm |
| Medium Sand | 0.25 to 0.50 | mm |
| Fine Sand | 0.125 to 0.250 | mm |
| Very Fine Sand | 0.075 to 0.125 | mm |

In the preferred invention method, Very Fine and Fine Sand grains are used to fill in the areas surrounding the Medium and Coarse Sand grains, adding to the opacity of the design and filling in the smaller spaces with color. Without the Very Fine and Fine Sand grains, either the textile substrate, or the base layer of ink will be visible through the sand print, and produce a substandard quality of print. The larger Medium and Coarse Sand grains are visibly identifiable as sand, and adds color, opacity, and texture to the design. This texture is both a visible reference and a tactile reference to sand.

Sand grains outside the preferred particle size range are deemed unusable. Grains smaller than 0.075 mm are similar in size to silt, and its powdery quality causes it to stick to the adhesive and interfere with bonding of larger grains of sand. Silt Sand grains of this size also do not have a textural component and thus will appear as a solid or solid color, which provides no differentiation from colored inks and shows no visible or textural references to sand. Grains larger than 2.0 mm do not allow sufficient amounts of ink to surround and encapsulate the sand and adhere it to the substrate. This leads to poor washability as sand particles will peel off with little manipulation.

Other types of small-grain particles having a characteristic similar to sand may also be applied to form an ornamented design on fabric, whether naturally occurring or man-made. By way of example, small-grain particles may be composed of silica, coral, shells, rocks, minerals, metals, plastic beads, precious and semi-precious stones, magnetic particles, glass, etc. The specific chemical or mineral constitution of the particles is not critical as long as it is inert and will not chemically bond or react with the adhesive. The preferred form for the particles is rounded, that is to say, the particles have rounded or non-sharp edges and are separated from one another by only a small distance. The rounded edges enable wet adhesive to flow more readily around the particles and into the interstices between particles. Particles with rounded edges may be formed naturally by erosion, or by polishing, or by manufacture in round shapes such as plastic or glass beads.

### Application of Adhesive Bottom Layer to Substrate

Referring to FIG. 2, reference numeral 1 denotes a flexible, porous substrate such as fabric for a textile article, for example, the front of a T-shirt. The textile substrate 1 may be a woven or knitted fabric or a nonwoven fabric. In a first step of applying a decorative design, the fabric has an adhesive material in a liquid form applied to it within the outlines of a decorative pattern 2 to be formed on the substrate. The adhesive, while liquid, will penetrate into interstices of the fabric and, upon curing, will become intimately bound to the fabric and firmly secured thereto. A preferred adhesive is a high-density plastisol-based ink which may be clear or tinted. Plastisol is a suspension of polyvinyl chloride (PVC) particles in a plasticizer carrier that flows as a liquid until heat cured. The plasticizer causes the PVC particles to become softer and more flexible. An example of a preferred plastisol ink is 10009 High Density Clear product available from PolyOne Corp., Kennesaw, Ga. Other liquid or semi-liquid adhesive materials may also be used. The adhesive material may be any form of film-forming thermoplastic applied in liquid form along with a plasticizer, which upon curing results in a flexible coherent film.

The adhesive bottom layer 2a may be applied by any suitable method, for example, using a cut-out stencil, a silk screen stencil, or by brushing on the pattern by hand. Other methods of application that may be used include roller printing or flatbed printing. Different screen or mesh sizes can be used to control the amount of adhesive applied. The wet adhesive can penetrate into the fabric substrate to enhance its bond therewith if no ink base is used. The decorative pattern 2 may be formed in any desired configuration, for instance, an image of a face or person, scenery, an animal, cartoon character, an object, such as a flower, or a word or phrase, such as “ALOHA FROM HAWAII”.

Referring to FIG. 3, after the patterned adhesive material is applied in an adhesive bottom layer 2a, a sand design is formed by a layer 3 of sand particles distributed over the adhesive bottom layer, and then an adhesive top layer 2b is applied on the sand design layer 3 and adhesive bottom layer 2a. The top and bottom layers 2a and 2b merge to form a homogenous adhesive layer embedding the layer 3 of sand particles. A base color or pattern may be screen-printed on the substrate surface initially to provide a background color or pattern on which the decorative design is to be superimposed.

### Application of Particle Layer

While the patterned adhesive material of the adhesive bottom layer 2a is still wet, a layer 3 of sand particles is applied on the patterned adhesive so as to completely cover the pattern and its outline edges. The sand particles can be applied in any manner desired. For example, particles may be sprinkled on the fabric substrate so as to cover the adhesive pattern. Alternate methods of application include blowing the particles with air, or cascading particles across the patterned adhesive. The particles will contact the exposed surface of the still-wet patterned adhesive so that essentially every part of the adhesive will have particles clinging thereto. The particles of different sizes will be distributed in a random fashion for a natural appearance.

After the particles have been deposited on the patterned adhesive and while it is still wet, the extraneous particles, i.e., those not in contact with the adhesive material are removed. This may be done by vacuuming, by inverting the substrate, or by blowing a stream of air across the substrate.

As an optional step, the layer of particles may be pressed into the adhesive bottom layer by applying pressure on the particle layer. This may be done by applying hand pressure, compressing the particles using a blank screen and squeegee, passing between a pair of platens, or by passing a roller over the panel and particles. The application of pressure should not flatten or create a smooth surface of particles, as it is preferable that the particles retain their random size distribution and appear natural to the eye and touch.

### Application of Adhesive Top Layer and Embedding of Sand Particles

A second (top) layer of adhesive material is applied on the patterned area 2 so that it encapsulates the layer of sand material along with the bottom adhesive layer. The interstices between particles allow the top wet adhesive to intermingle with the bottom wet adhesive, called a “wet-on-wet” application, allowing the two to merge and become one homogeneous layer. The homogeneous layer forms a flexible film upon curing that permanently embeds the sand layer and creates a sealed edge around the sand decoration. The adhesive top layer may be applied in any manner well known to the art including, for instance, silk screen printing, stencil printing, roller printing and stamp printing. This will form an excellent, secure bond between the individual particles and the cured adhesive. The period of infrared curing may vary depending on ambient surroundings. It has been found that typically about 3 to 4 minutes at 300 degrees is sufficient to ensure setting of the adhesive and excellent laminating of the particles thereto.

After the adhesive has cured, the adhered particles are firmly bonded in place and any extraneous particles may be removed as by brushing manually or with a machine and/or by shaking or blowing pressurized air over the design.

High-density plastisol ink is a high-viscosity ink that is designed to be printed with the aid of a stencil. The typical manufacturer's recommended stencil film thickness is in the range of 200-400 microns on a mesh screen that has 24-110 threads per inch. The lower mesh screen count is due to a relatively large thread diameter and more space between the threads allowing more ink to pass through the screen creating a thicker deposit. This is particularly recommended for specialty inks such as glitter, glow and high density.

Manufacturers typically recommend that high-density plastisol ink never be printed wet-on-wet. High-density Inks are stickier and thicker than normal and printing wet-on-wet can cause build up to occur. Build up is excessive ink that has been left on the backs or undersides of the screens caused when the second layer of ink either doesn't adhere properly to the first layer or when the second layer lifts off a portion of the first layer of ink. This can cause the design to lose clarity, sharpness, detail, and/or lead to poor print quality. When printing successive layers of high-density inks, manufacturers recommend a print-flash/heat-print method, wherein a flash heat of about 220 degrees Fahrenheit is applied to the first layer of high-density ink to cause the ink to gel, partially curing the ink and creating a film on the ink's surface that is dry enough to allow a second layer of wet ink to be printed on the first layer without causing build up.

In the wet-on-wet method preferred in the present invention, we do not use a stencil film to create the screen. Our method uses a photocure emulsion process to create a stencil on a higher-count mesh screen. This process is typical in the industry for lower-viscosity colored plastisol inks, but not for specialty or high-density Inks. Compared to a thick film stencil, the emulsion process creates a stencil that is very thin, usually under 200 microns. The emulsion stencil is created on a screen with mesh count that is above 110 threads per inch, and preferably 156 threads per inch. This higher mesh screen count has smaller thread diameter and less space between the threads allowing for more control as less ink passes through the screen onto the substrate.

When printing in the wet-on-wet method as described herein, the single layer of sand that is applied on top of the first layer of adhesive acts as a dry layer. This dry layer of sand is partially embedded in the first layer of adhesive, that is, only the bottom portion of sand which is in contact with the first layer of adhesive is wet. The top portions of the sand layer, or the areas of sand not exposed to the first layer of adhesive is in effect dry of any adhesives. This creates a dry surface in which now the second layer of wet adhesive can be applied in contact. The surface tension of the sand to the still-wet first adhesive layer is enough to keep the sand and first adhesive layer from lifting when the second layer of wet adhesive is applied. Flash curing in between the two layers of adhesive, either before or after the sand is applied is unnecessary and can even be detrimental. A flash cure before the sand is applied will cause the first layer of adhesive to gel, forming a skin that the sand will no longer adhere to. A flash cure after the sand has been applied to the first layer of adhesive, would serve no purpose as it will require additional time to raise the recommended gel cure temperature and then require more time to cool down to the normal working environment. The flash cure may not in any way increase the bond between the layers of adhesive, and may in fact decrease the bond by creating two separate layers of adhesive instead of the single homogenous layer in our method. Any increase in production time or use of unnecessary resources such as electricity in the flash cure, serve to only increase cost and is contrary to our method.

A flash cure may be applied as an optional step in our method when a base design or image is printed before the layer of sand is superimposed upon it. If the base design or image is printed with plastisol ink (normal colored ink common in the industry), the flash cure would set the base design before the first adhesive layer and sand layer are applied.

### Preferred Implementation Example

In a preferred implementation example, Super High Density Clear (SHDC) plastisol ink is used as the film-forming adhesive. It is recommended as a clear carrier and/or adhesive for certain types of flock such as metal foil and plastic beads. When heat cured, SHDC plastisol ink forms an excellent bond with textile substrates.

An automated screen printing machine may be used to ensure consistent pressure and angle of the squeegee when applying the first and second layers of SHDC ink. Any change in pressure or angle may cause the sand and ink to be lifted off the design, rendering the printing defective.

The sand layer may be printed directly onto the textile substrate, or may be superimposed on top of another printed layer of color, colors, or a design image. Once the sand is deposited on to the initial SHDC ink layer, pressure is applied to set the sand with a blank screen and squeegee applying pressure, a roller, a press, etc. On top of the first layer of SHDC ink and the sand, a second layer of clear SHDC ink is applied through another stenciled screen. The two adhesive layers merge to create a homogeneous adhesive layer in which the sand is suspended. Following manufacturer's recommendations for heat curing, the SHDC ink/sand/SHDC ink laminate is cured to an internal temperature of 300-350 degrees F.

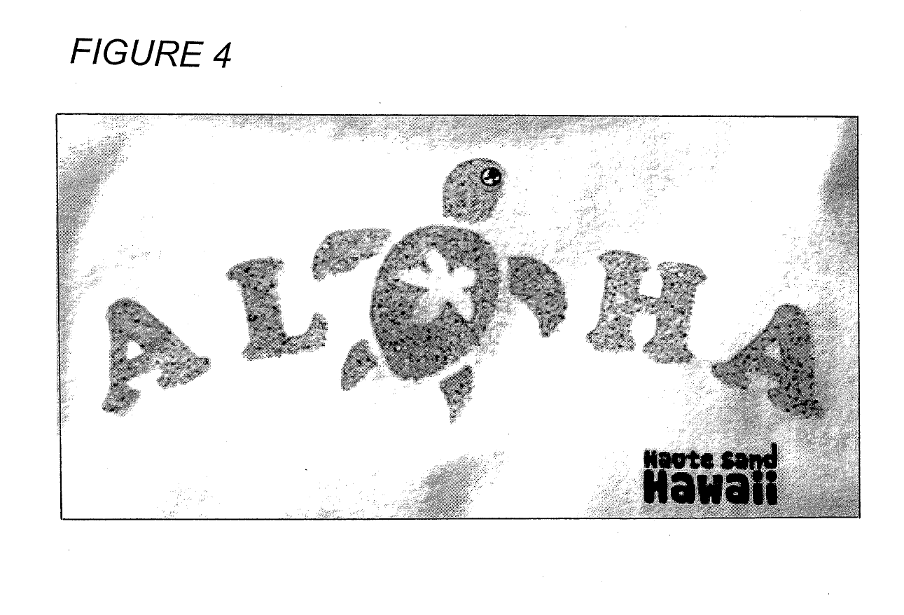

FIG. 4 illustrates an example of a resulting ornamented design of sand particles formed on the front of a T-shirt. The sand design on the fabric is encapsulated in the cured film and is strongly bonded to the T-shirt fabric. The result is an ornamented clothing item that has a fresh-looking and clear design image, and is long-lasting over many washing or drying cycles, easy to produce on a mass scale, and inexpensive.

Many modifications and variations may be devised given the above description of the principles of the invention. It is intended that all such modifications and variations be considered as included within this invention, as defined in the following patent claims.

1-16. (canceled)

17. An product produced by the method defined in claim 1 as an ornamented textile product, comprising:
a textile article made of a porous woven fabric having a surface to be ornamented with a decorative pattern of granular particles thereon;
a layer of granular particles forming a decorative pattern which is applied in a given patterned area on the surface of the porous woven fabric to be ornamented;
a bottom adhesive layer of a film-forming adhesive material applied on the surface of the porous woven fabric, which when applied in a liquid form covers the patterned area so as to penetrate into interstices of the porous woven fabric and onto which the layer of granular particles is applied; and
a top adhesive layer of a film-forming adhesive material applied over the bottom adhesive layer and the layer of granular particles thereon, which when applied in a liquid form covers the patterned area so as to encapsulate the layer of granular particles in between with the bottom adhesive layer and penetrates into interstices of the granular particles and intermingle with the film-forming adhesive material of the bottom adhesive layer so that the top and bottom adhesive layers merge into a combined homogenous layer,
wherein the combined homogeneous layer when cured forms a flexible film layer bonded to the surface of the porous woven fabric that permanently embeds the layer of granular particles and creates a sealed edge around the layer of granular particles forming the decorative pattern in the patterned area.

18. A product as defined in claim 17, wherein the ornamented textile product is a sand-decorated T-shirt.

19. A product as defined in claim 17, wherein the ornamented textile product is an article of soft goods such as clothing, bags, bedding, or curtains.

20. (canceled)

21. A product as defined in claim 17, wherein the granular particles are sand particles.

22. A product as defined in claim 21, wherein the sand particles are in a range of sand particle sizes from 0.075 mm to 2.0 mm in diameter.

23. A product as defined in claim 21, wherein the sand particles are naturally occurring sand that is cleaned to be substantially free of dirt sediment, salt crystals, and organic matter.

24. A product as defined in claim 17, wherein the film-forming adhesive material in a liquid form is a plastisol ink containing polyvinyl chloride (PVC) ink particles in a plasticizer carrier.

25. A product as defined in claim 17, wherein a base color or decorative background is first applied on the surface of the porous woven fabric and onto which the bottom adhesive layer is applied.

26. A product as defined in claim 17, wherein the granular particles are composed of a material selected from the group consisting of sand, silica, coral, shells, rocks, minerals, metals, plastic beads, precious and semi-precious stones, magnetic particles, and glass.
